(19) United States
(12) Patent Application Publication
(10) Pub. No.: US 2025/0378569 A1
(43) Pub. Date: Dec. 11, 2025

(54) DETERMINING POSITIONS OF OBJECTS BASED ON IMAGES AND GROUND-PLANE MODELS

(71) Applicant: QUALCOMM Incorporated, San Diego, CA (US)

(72) Inventor: Tommy KARLSSON, Linköping (SE)

(21) Appl. No.: 18/739,204

(22) Filed: Jun. 10, 2024

(51) Int. Cl. G06T 7/70; G06T 5/20; G06V 20/56

(52) U.S. Cl. CPC G06T 7/70; G06T 5/20; G06V 20/588

(57) ABSTRACT

Systems and techniques are described herein for determining positions of objects. For instance, a method for determining positions of objects is provided. The method may include obtaining a first camera position related to a first image; obtaining a first vector, the first vector being based on the first camera position and a representation of an object in the first image; obtaining a first road-height model comprising three-dimensional positions of a road on which the object is positioned, wherein the first road-height model is related to the first camera position; obtaining a second road-height model after obtaining the first road-height model; and projecting the first vector from the first camera position to a point related to the second road-height model to determine a first object position.

### TECHNICAL FIELD

The present disclosure generally relates to object detection and/or tracking. For example, aspects of the present disclosure include systems and techniques for determining positions of objects based on images and ground-plane models.

### BACKGROUND

Object detection can be used to identify objects (e.g., from a digital image or a video frame of a video clip). Object tracking can be used to track a detected object over time. Object detection and tracking can be used in different fields, including autonomous driving, video analytics, security systems, robotics, aviation, among many others. In some fields, a vehicle (or other system) can determine positions of objects in an environment so that the vehicle (or other system) can accurately navigate through the environment (e.g., to make accurate motion planning and trajectory planning decisions).

Examples of fields where an object may be detected and/or tracked include autonomous driving by autonomous driving systems (e.g., of autonomous vehicles), autonomous navigation by a robotic system (e.g., an automated vacuum cleaner, an automated surgical device, etc.), aviation systems, among others. It may be important for autonomous driving systems, as an example, to be able to detect and/or track objects of, on, or related to a road, such as lane markings, lane edges, traffic markings, and/or other symbols on a road.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining positions of objects. According to at least one example, a method is provided for determining positions of objects. The method includes: obtaining a first camera position related to a first image; obtaining a first vector, the first vector being based on the first camera position and a representation of an object in the first image; obtaining a first road-height model comprising three-dimensional positions of a road on which the object is positioned, wherein the first road-height model is related to the first camera position; obtaining a second road-height model after obtaining the first road-height model; and projecting the first vector from the first camera position to a point related to the second road-height model to determine a first object position.

In another example, an apparatus for determining positions of objects is provided that includes at least one memory and at least one processor (e.g., configured in circuitry) coupled to the at least one memory. The at least one processor configured to: obtain a first camera position related to a first image; obtain a first vector, the first vector being based on the first camera position and a representation of an object in the first image; obtain a first road-height model comprising three-dimensional positions of a road on which the object is positioned, wherein the first road-height model is related to the first camera position; obtain a second road-height model after obtaining the first road-height model; and project the first vector from the first camera position to a point related to the second road-height model to determine a first object position.

In another example, a non-transitory computer-readable medium is provided that has stored thereon instructions that, when executed by one or more processors, cause the one or more processors to: obtain a first camera position related to a first image; obtain a first vector, the first vector being based on the first camera position and a representation of an object in the first image; obtain a first road-height model comprising three-dimensional positions of a road on which the object is positioned, wherein the first road-height model is related to the first camera position; obtain a second road-height model after obtaining the first road-height model; and project the first vector from the first camera position to a point related to the second road-height model to determine a first object position.

In another example, an apparatus for determining positions of objects is provided. The apparatus includes: means for obtaining a first camera position related to a first image; means for obtaining a first vector, the first vector being based on the first camera position and a representation of an object in the first image; means for obtaining a first road-height model comprising three-dimensional positions of a road on which the object is positioned, wherein the first road-height model is related to the first camera position; means for obtaining a second road-height model after obtaining the first road-height model; and means for projecting the first vector from the first camera position to a point related to the second road-height model to determine a first object position.

In another example, a method is provided for determining positions of objects. The method includes: obtaining a filtered camera position; obtaining a filtered vector, the filtered vector being based on the filtered camera position, and a filtered object position, where in the filtered object position is based on a first road-height model; obtaining a second road-height model, wherein the second road-height model comprises three-dimensional positions of a road on which an object is positioned; and projecting the filtered vector from the filtered camera position to a point related to the second road-height model to determine an updated filtered object position.

In another example, an apparatus for determining positions of objects is provided that includes at least one memory and at least one processor (e.g., configured in circuitry) coupled to the at least one memory. The at least one processor configured to: obtain a filtered camera position; obtain a filtered vector, the filtered vector being based on the filtered camera position, and a filtered object position, where in the filtered object position is based on a first road-height model; obtain a second road-height model, wherein the second road-height model comprises three-dimensional positions of a road on which an object is positioned; and project the filtered vector from the filtered camera position to a point related to the second road-height model to determine an updated filtered object position.

In another example, a non-transitory computer-readable medium is provided that has stored thereon instructions that, when executed by one or more processors, cause the one or more processors to: obtain a filtered camera position; obtain a filtered vector, the filtered vector being based on the filtered camera position, and a filtered object position, where in the filtered object position is based on a first road-height model; obtain a second road-height model, wherein the second road-height model comprises three-dimensional positions of a road on which an object is positioned; and project the filtered vector from the filtered camera position to a point related to the second road-height model to determine an updated filtered object position.

In another example, an apparatus for determining positions of objects is provided. The apparatus includes: means for obtaining a filtered camera position; means for obtaining a filtered vector, the filtered vector being based on the filtered camera position, and a filtered object position, where in the filtered object position is based on a first road-height model; means for obtaining a second road-height model, wherein the second road-height model comprises three-dimensional positions of a road on which an object is positioned; and means for projecting the filtered vector from the filtered camera position to a point related to the second road-height model to determine an updated filtered object position.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is an image illustrating an example environment in which systems and techniques may operate, according to various aspects of the present disclosure;

FIG. 2 is a diagram illustrating an example simulated three-dimensional (3D) environment that may be used to determine object positions, according to various aspects of the present disclosure;

FIG. 3A is a diagram illustrating an example environment in which a vehicle may determine an object position, according to various aspects of the present disclosure;

FIG. 3B is a diagram illustrating an example environment in which vehicle may determine an object position, according to various aspects of the present disclosure;

FIG. 4 is a diagram illustrating an example environment in which a vehicle may determine a position of an object, according to various aspects of the present disclosure;

FIG. 5 is a diagram of an example environment in which a vehicle may determine an object position, according to various aspects of the present disclosure;

FIG. 6 is a block diagram illustrating an example system that may determine object positions, according to various aspects of the present disclosure;

FIG. 7 is a block diagram illustrating an example system that may determine object positions, according to various aspects of the present disclosure;

FIG. 8 is a block diagram illustrating an example system that may determine object positions, according to various aspects of the present disclosure;

FIG. 9 is a diagram of an example environment in which a vehicle may determine an object position, according to various aspects of the present disclosure;

FIG. 10 is a diagram of an example environment in which a vehicle may determine an object position, according to various aspects of the present disclosure;

FIG. 11 is a block diagram illustrating an example system that may determine object positions, according to various aspects of the present disclosure;

FIG. 12 is a flow diagram illustrating an example process for determining object positions, in accordance with aspects of the present disclosure;

FIG. 13 is a flow diagram illustrating an example process for determining object positions, in accordance with aspects of the present disclosure;

FIG. 14 is a block diagram illustrating an example of a deep learning neural network that can be used to perform various tasks, according to some aspects of the disclosed technology;

FIG. 15 is a block diagram illustrating an example of a convolutional neural network (CNN), according to various aspects of the present disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Object detection and tracking can be used in various types of systems, including autonomous driving systems, video analytics, security systems, robotics systems, aviation systems, among others systems. In such systems, a vehicle (or other object) may move through an environment and track objects in the environment to determine positions of the objects. Determining the positions of objects in the environment may allow the vehicle (or other system) to accurately navigate through the environment by making intelligent motion-planning and trajectory-planning decisions.

In the present disclosure, the term “detection” may refer to identifying pixels of an image as an object and/or classifying the object. In the present disclosure, the term “tracking” may refer to detecting the object in multiple images. The object may be in different positions within the multiple images, for example, based on a camera that captures the images moving between frames. Additionally or alternatively, the term “tracking” may refer to determining a position of the object (e.g., relative to a camera that captured the image) and/or determining the position based on the multiple images.

It may be useful for driving systems (e.g., autonomous, semi-autonomous, or assisted driving systems, such as an advanced driver assistance system (ADAS)) of vehicles to detect and/or track objects. These capabilities may important even for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may provide information to a driver based on detected and/or tracked objects.

For example, it may be useful for an ADAS to track objects in images captured by a camera of the ADAS. For instance, it may be useful for the ADAS to track objects of, on, or related to a road, such as lane markings, lane edges, traffic markings, and/or other symbols on a road. As an example, tracking lane markings may enable the ADAS to steer a vehicle to keep the vehicle within lane boundaries.

Some techniques may capture images of a road, obtain road-height models, project (in a simulated three-dimensional space) vectors from a camera-center point, through pixels of images representing an object in an image plane onto the road-height model, and determine positions of objects based on where the vectors intersect the road-height models. Such techniques may be accurate for accurate road-height models. However, if a road-height model is inaccurate, the determinations of the positions of the objects will be inaccurate as well.

Systems, apparatuses, methods (also referred to as processes), and computer-readable media (collectively referred to herein as “systems and techniques”) are described herein for determining positions of objects. For example, the systems and techniques described herein may obtain an image of a road including objects of, on, or related to a road, such as lane markings, lane edges, traffic markings, and/or other symbols on a road. Additionally, the systems and techniques may obtain a first road-height model. The systems and techniques may detect an object in the images and project a vector (in a simulated three-dimensional (3D) space) from a camera-center point through a representation of the object in the image in an image plane to the first road-height model. Additionally, the systems and techniques may determine a 3D position of the object (e.g., an object position) based on where the vector intersects the first road-height model. Further, the systems and techniques may store the vector and a camera position (e.g., a 3D position of the camera-center point corresponding to the image).

After obtaining the first road-height model, the systems and techniques may obtain a second road-height model. The second road-height model may be more accurate, for at least some points, than the first road-height model. For example, the first road-height model may be based on a first image, light detection and ranging (LIDAR) capture, or radio detection and ranging (RADAR) capture of the road and may be most accurate at points closest to the camera, LIDAR system, or RADAR system. The accuracy of the first road-height model may decrease for points farther from the camera, LIDAR system or RADAR system. The second road-height model may be based on a second image, LIDAR capture, or RADAR capture of the road captured from farther down the road than the first image, LIDAR capture, or RADAR capture. The second road-height model may be more accurate at points closest to the camera, LIDAR system, or RADAR system and less accurate at points farther from the camera, LIDAR system, or RADAR system. Because the second image, LIDAR capture, or RADAR capture is captured from farther down the road than the first image, LIDAR capture, or RADAR capture, the second road-height model may be more accurate for at least some points farther down the road than the first road-height model.

The systems and techniques may project the stored vector from the stored camera position to the second road-height model and determine an updated object position based on the intersection between the vector and the second road-height model. The updated object position may be more accurate than the prior object position based on second road-height model being more accurate (for at least some points) than the first road-height model.

The above-described process of projecting vectors, storing the vectors and camera positions, obtaining road-height models, and updating object positions based on newer obtained road-height models may be repeated any number of times. For example, while a vehicle is travelling, a camera of the vehicle may continuously (e.g., at a frame-capture rate of 30 frames-per-second (fps)) capture images. Additionally or alternatively, the vehicle may determine road-height models (e.g., using images, LIDAR and/or RADAR) continuously (e.g., at a rate of several per second). The systems and techniques may store any number of vectors (for example, 25, 50, 100, or more) and update an object position of an object based on the number of vectors and a most-recently-obtained road-height model. For example, the systems and techniques may determine an object position based on each vector and the most-recently-obtained road-height model. Then the systems and techniques may take an average (e.g., a weighted average that weights object positions based on newer images higher) of the object positions to determine an updated object position. Additionally or alternatively, the process may be repeated for any number of objects in the images.

Additionally or alternatively, rather than storing a number of vectors for each object, the systems and techniques may use a Kalman-filter-based technique to update a vector for each object as new road-height models are obtained and as the vectors are projected to the new road-height models. For example, the systems and techniques may detect an object in a first image. The systems and techniques may project a first vector from a camera-center point (e.g., a first camera position) through a representation of the object in the first image in an image plane onto a most-recently-obtained road-height model (e.g., a “first” road-height model). The systems and techniques may store the first vector and the first camera position.

Thereafter, the systems and techniques may obtain a second image of the object and a second road-height model. The systems and techniques may project the first vector to the second road-height model to determine a first object position. Additionally, the systems and techniques may project a second vector from a second camera position (e.g., the position from which the second image was captured) through a representation of the object in the second image in an image plane onto the second road-height model to determine a second object position.

The systems and techniques may determine a third object position based on the first object position and the second object position (e.g., based on a weighted average between the first object position and the second object position). The systems and techniques may determine a third vector between the second camera position and the third object position. The systems and techniques may store the third vector as a filtered vector and the second camera position as a filtered camera position.

Thereafter, the systems and techniques may determine further object positions based on the filtered vector and the filtered camera position. Then the systems and techniques may determine further weighted averages based on the further object positions and object positions determined based on most-recently-obtained images and most-recently-obtained road-height models. The systems and techniques may update and store the filtered vector and the filtered camera position. For example, the systems and techniques may use a Kalman filter to track a filtered vector between an object position (that updates based on new road-height models and an updated camera positions).

In the present disclosure, a road-height model is given as an example of a ground-plane model. For example, the systems and techniques may be used to determine positions of objects on any surface. For instance, the systems and techniques may be used to determine positions of objects on a path, a dirt road, dirt, grass, rocks, a floor, carpet, etc. Additionally, the model may be a profile, for example, a one-dimensional profile that may be projected into a simulated three-dimensional space such that the projected profile may be intersected by a vector.

In the present disclosure, references to a vector “intersecting” with a model may refer to the vector being projected to a point of intersection between the vector and the model. The model may or may not include the point of intersection. For example, the model may include discrete points and the point of intersection may be determined to be between the discrete points. Various aspects of the application will be described with respect to the figures below.

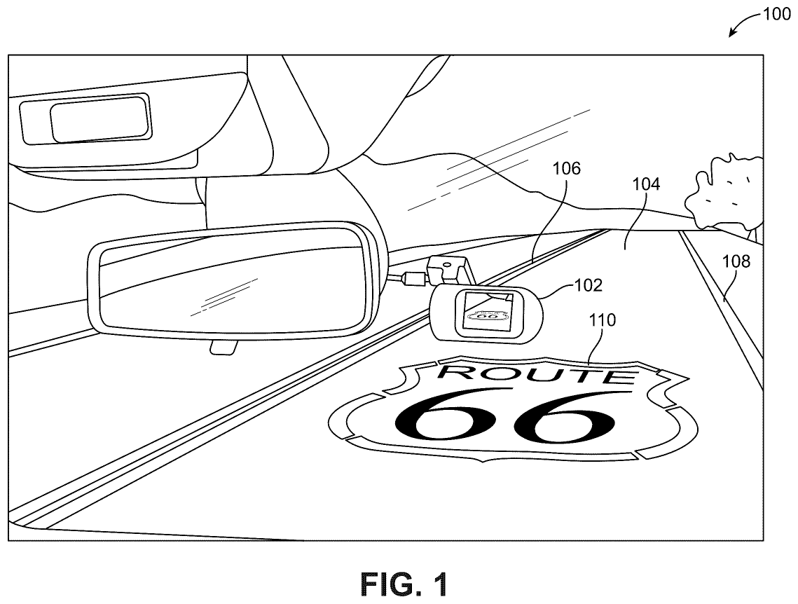

FIG. 1 is an image illustrating an example environment 100 in which systems and techniques may operate, according to various aspects of the present disclosure. For example, a camera 102 may be included in, or attached to, a vehicle. Camera 102 is illustrated attached to a windshield as an example. Other cameras may be positioned in other locations on a vehicle, such as on or near a front fender or grill, on side-view mirrors, or on top of the vehicle. Camera 102 may capture images of an environment of the vehicle, including a road 104 on which the vehicle is travelling. The images of road 104 may include objects of, on, or related to road 104. Such objects may include, as examples, lane dividers 106, lane edges 108, and/or road symbols 110. It may be useful for an ADAS, according to any level of autonomy, to have accurate position information regarding such objects, for example, to enable the ADAS to assist in lane-keeping, to recognize road signs, such as crosswalks. To determine accurate position information for objects, the systems and techniques may detect and track objects through one or more images. The systems and techniques may detect objects using a machine-learning object-detection model which may be trained to detect objects.

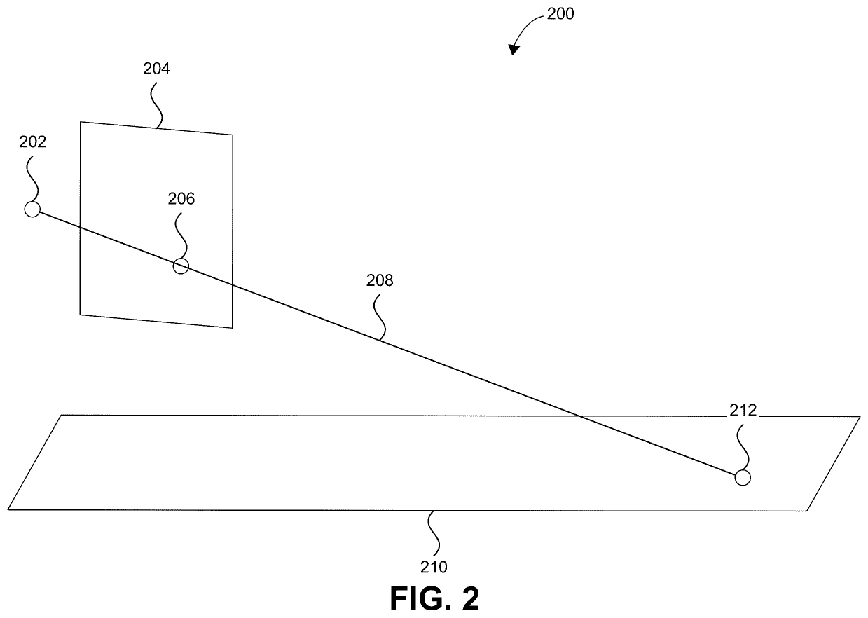

FIG. 2 is a diagram illustrating an example simulated three-dimensional (3D) environment 200 that may be used to determine object positions, according to various aspects of the present disclosure. Camera-center point 202 represents a focal point of a camera used to capture an image. Image plane 204 represents an image plane. Pixels of an image may be simulated at image plane 204. Object representation 206 represents a representation of an object in an image as the image is simulated at image plane 204. Vector 208 represents a vector starting at camera-center point 202 and projected through object representation 206. Road-height model 210 represent a road-height model in simulated 3D environment 200. The systems and techniques may determine object position 212 as the point of simulated 3D environment 200 at which vector 208 intersects with road-height model 210.

For example, the systems and techniques may obtain an image captured by a camera at a camera position. The systems and techniques may determine the camera position (e.g., in a reference coordinate system, such as latitude and longitude or in an ego-vehicle-centric coordinate system). The camera position may correspond to camera-center point 202. The systems and techniques may detect an object in the image, for example, the systems and techniques may determine that object representation 206 represents an object.

The systems and techniques may simulate simulated 3D environment 200, for example, by simulating the image in image plane 204 and projecting vector 208 from camera-center point 202 through object representation 206. Further, the systems and techniques may obtain road-height model 210. Road-height model 210 may have coordinates in the reference coordinate system or the ego-vehicle-centric coordinate system. The systems and techniques may simulate road-height model 210 in simulated 3D environment 200. The systems and techniques may determine that object position 212 is the point at which vector 208 intersects with road-height model 210. The systems and techniques may determine object position 212 in the reference coordinate system or the ego-vehicle-centric coordinate system (based on the camera position and/or road-height model 210). References to simulating simulated 3D environment 200 may refer applying three-dimensional geometry to points, planes, vectors, and road-height model 210.

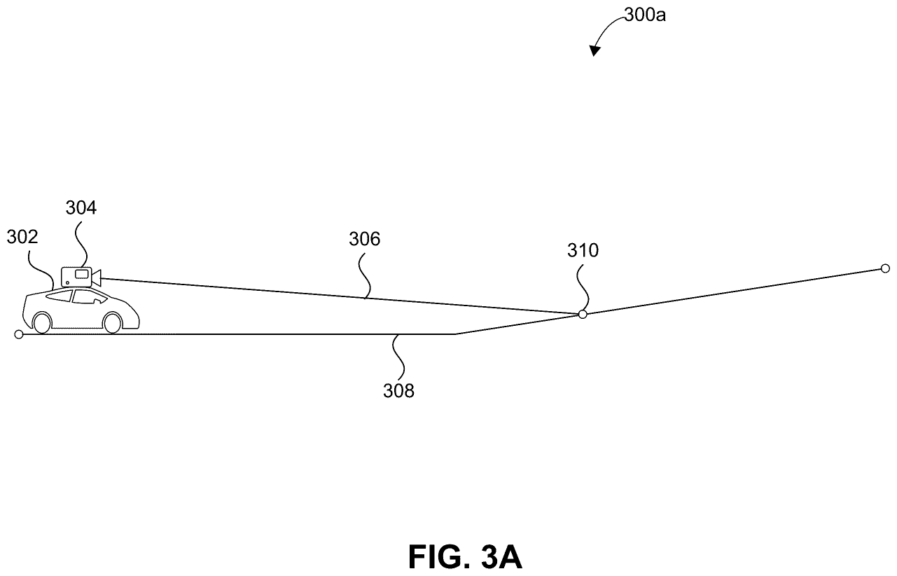

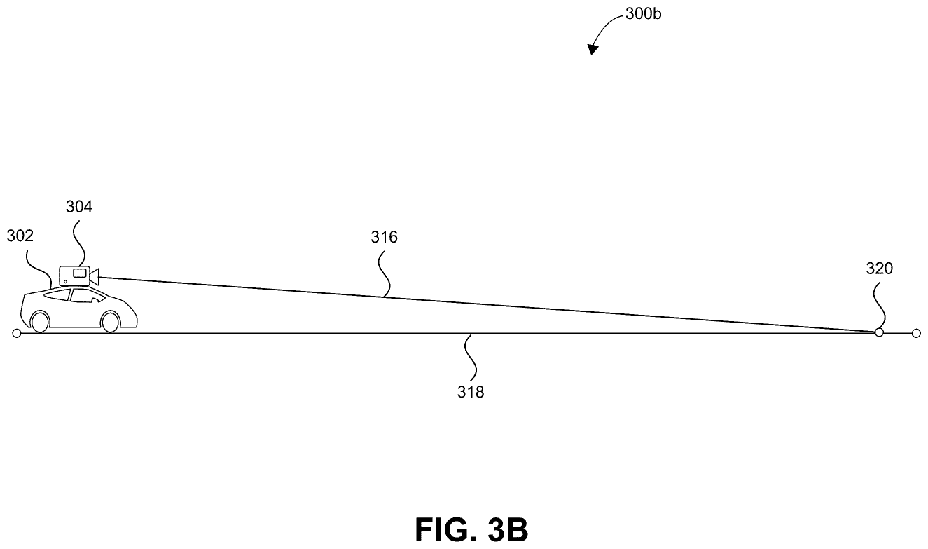

FIG. 3A is a diagram illustrating an example environment 300a in which a vehicle 302 may determine an object position 310, according to various aspects of the present disclosure. For example, vehicle 302 may include a camera 304. Camera 304 may capture an image of an object. Vehicle 302 may project a vector 306 from a camera center position of camera 304 through a representation of the object in the image (the image being in an image plane) to a road-height model 308 to determine object position 310 (e.g., as described with regard to FIG. 2).

In the present disclosure, references to a vehicle performing operations (e.g., determining object positions) may refer to a computing system of the vehicle performing the operations. For example, vehicle 302 may include a computing system including at least one processor configured to perform the operations described with regard to vehicle 302.

FIG. 3B is a diagram illustrating an example environment 300b in which vehicle 302 may determine an object position 320, according to various aspects of the present disclosure. For example, camera 304 may capture an image of an object. Vehicle 302 may project a vector 316 from a camera center position of camera 304 through a representation of the object in the image (the image being in an image plane) to a road-height model 318 to determine object position 320 (e.g., as described with regard to FIG. 2).

The object, the image of the object, and the camera position may be the same between environment 300a and environment 300b. As a result, the direction of vector 306 may be the same as the direction of vector 316. Road-height model 308 may be different from road-height model 318. Because road-height model 308 is different from road-height model 318, object position 310 may be different from object position 320.

FIG. 3A and FIG. 3B illustrate that determining an object position depends on a road-height model and different road-height models will result in different object-position determinations.

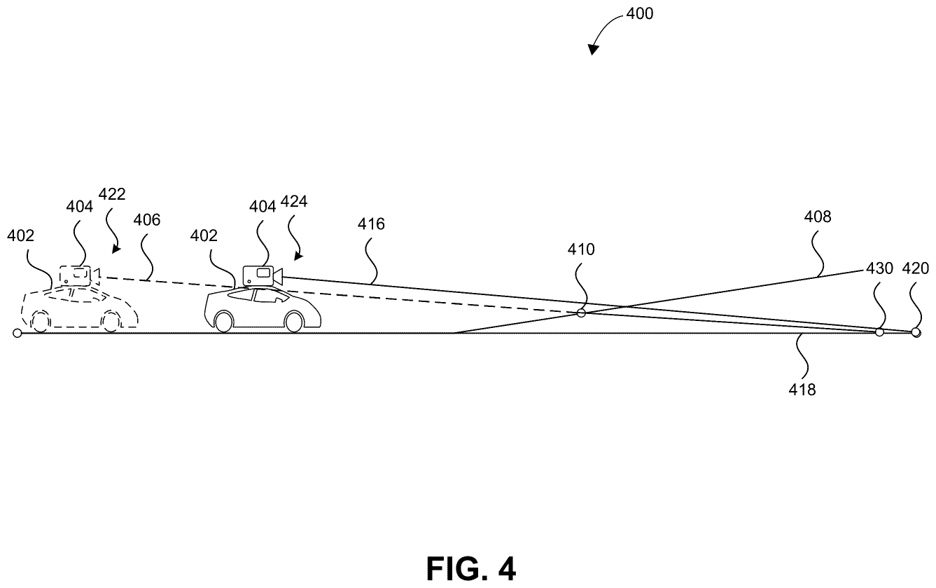

FIG. 4 is a diagram illustrating an example environment 400 in which a vehicle 402 may determine a position of an object at two times, according to various aspects of the present disclosure. For example, vehicle 402 may include a camera 404. While camera 404 is at camera position 422, camera 404 may capture an image of an object. Additionally, while camera 404 is at camera position 422, road-height models 408 may be a most-recently-obtained road-height model. For example, vehicle 402 may determine road-height model 408 while camera 404 is at camera position 422 (e.g., based on images, light detection and ranging (LIDAR) and/or radio detection and ranging (RADAR) captures. Vehicle 402 may project a vector 406 from camera position 422 through a representation of the object in the image (the image being in an image plane) to road-height model 408 to determine object position 410 (e.g., as described with regard to FIG. 2).

At another time (e.g., a later time, such as after vehicle 402 has travelled down the road), while camera 404 is at camera position 424, camera 404 may capture another image of the object. Additionally, while camera 404 is at camera position 424, road-height models road-height model 418 may be a most-recently-obtained road-height model. For example, vehicle 402 may determine road-height model 418 while camera 404 is at camera position 424. Road-height model 418 may be more accurate than road-height model 408. For example, vehicle 402 may be better able to determine road-height models for points closer to vehicle 402 than for points farther away from vehicle 402. Thus, because camera position 424 may be farther down the road than camera position 422, road-height model 418 may be more accurate for points farther down the road than road-height model 408 is for the points farther down the road. Vehicle 402 may project a vector 416 from camera position 424 through a representation of the object in the image (the image being in an image plane) to a road-height model 418 to determine object position 420 (e.g., as described with regard to FIG. 2).

It may be beneficial to use multiple determined object positions to improve determined object positions (e.g., by averaging or performing a weighted average). For example, using multiple determined object positions may decrease noise (e.g., variance) in the determined object positions. However, averaging object position 410 with object position 420 may increase noise based on the difference between object position 410 and object position 420.

The systems and techniques may update object position 410 based on road-height model 418. For example, the systems and techniques may store camera position 422 and vector 406. Then, when road-height model 418 is obtained, the systems and techniques may project vector 406 from camera position 422 along the direction of vector 406 to road-height model 418 to determine updated object position 430. Updated object position 430 may be more accurate than object position 410 based on road-height model 418 being more accurate than road-height model 408. Vehicle 402 may perform an average (e.g., a weighted average) of object position 420 and updated object position 430 to determine a final object position.

Vehicle 402 may store any number of camera positions and corresponding vectors. For example, vehicle 402 may include a rolling window of the most-recently-obtained 25, 50, or 100 camera positions and vectors. Further, vehicle 402 may project the stored vectors from the stored camera positions to a most-recently-obtained road-height model to determine object positions. The systems and techniques may average the determined object positions to determine the final object position.

Vehicle 402 may manage coordinate systems of the various images, vectors, camera positions, and/or object positions. For example, vehicle 402 may track a pose (including position and orientation) of camera 404 over time. Further, vehicle 402 may transform positions (e.g., camera positions, vectors, and/or object positions) when comparing positions between coordinate systems. For example, vehicle 402 may determine object position 420 and updated object position 430 in a common coordinate system, for example, a reference coordinate system that is stationary (e.g., having a fixed origin). Alternatively, vehicle 402 may determine object position 420 and updated object position 430 in an ego-centric coordinate system based on a position of vehicle 402 while camera 404 is at camera position 424.

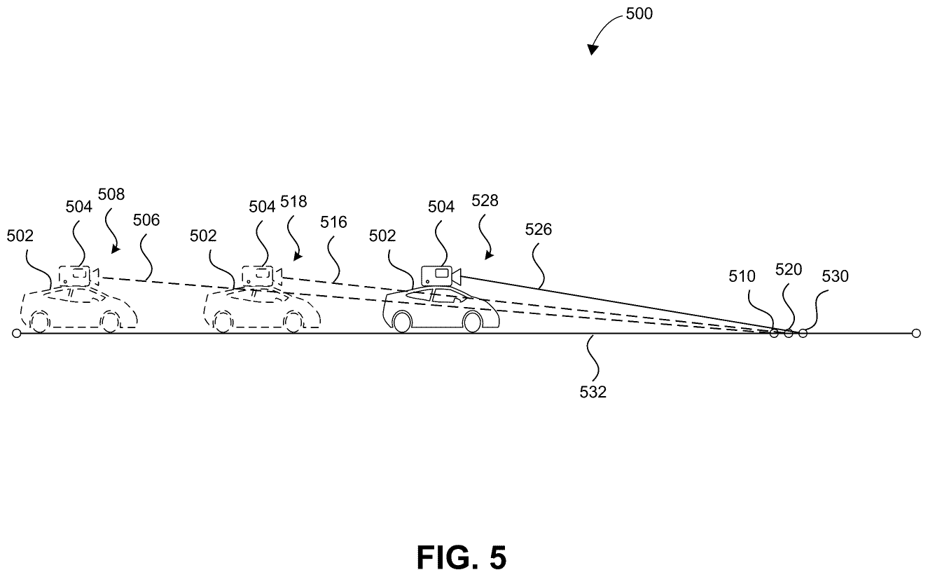

For example, FIG. 5 is a diagram of an example environment 500 in which a vehicle 502 may determine an object position, according to various aspects of the present disclosure. Vehicle 502 may include a camera 504. While camera 504 is at camera position 508, camera 504 may capture a first image. Vehicle 502 may determine a vector 506 from camera position 508 through a representation of an object in the first image in an image plane (e.g., as described with regard to FIG. 2). Vehicle 502 may determine an object position based on vector 506 and a most-recently-obtained road-height model (as of the time that camera 504 is at camera position 508). Vehicle 502 may store vector 506 and camera position 508. Vehicle 502 may conserve memory by not storing the first image, the most-recently-obtained road-height model, and/or an object position based on the first image and the most-recently-obtained road-height model.

While camera 504 is at camera position 518, camera 504 may capture a second image. Vehicle 502 may determine a vector 516 from camera position 518 through a representation of the object in the second image in an image plane (e.g., as described with regard to FIG. 2). Vehicle 502 may determine an object position based on vector 516 and a most-recently-obtained road-height model (as of the time that camera 504 is at camera position 518). Vehicle 502 may store vector 516 and camera position 518. Vehicle 502 may conserve memory by not storing the second image, the most-recently-obtained road-height model, and/or an object position based on the second image and the most-recently-obtained road-height model.

While camera 504 is at camera position 528, vehicle 502 may obtain road-height model 532. Additionally, while camera 504 is at camera position 528, camera 504 may capture a third image. Vehicle 502 may determine a vector 526 from camera position 528 through a representation of the object in the third image in an image plane (e.g., as described with regard to FIG. 2). Vehicle 502 may determine object position 530 based on vector 526 and road-height model 532.

Additionally, after obtaining road-height model 532, vehicle 502 may determine object position 520 based on vector 516, camera position 518, and road-height model 532. For example, vehicle 502 may project vector 516 from camera position 518 to road-height model 532. Similarly, vehicle 502 may determine object position 510 based on vector 506, camera position 508, and road-height model 532. Further, vehicle 502 may determine additional object positions based on road-height model 532 and additional stored camera positions and stored vectors (not illustrated in FIG. 5).

Vehicle 502 may manage coordinate systems of the various images, vectors, camera positions, and/or object positions. For example, vehicle 502 may track a pose (including position and orientation) of camera 504 over time. Further, vehicle 502 may transform positions (e.g., camera positions, vectors, and/or object positions) when comparing positions between coordinate systems. For example, vehicle 502 may determine object position 510, object position 520, and object position 530 in a common coordinate system, for example, a reference coordinate system that is stationary (e.g., having a fixed origin). Alternatively, vehicle 502 may determine object position 510, object position 520 and object position 530 in an ego-centric coordinate system based on a position of vehicle 502 while camera 504 is at camera position 528.

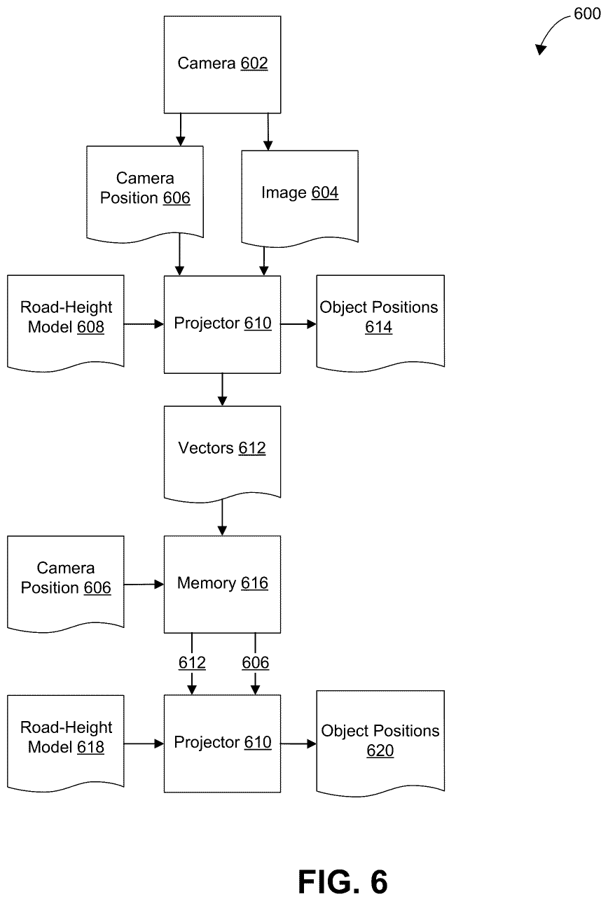

FIG. 6 is a block diagram illustrating an example system 600 that may determine object positions, according to various aspects of the present disclosure. System 600 illustrates several operations associated with determining object positions as blocks for descriptive purposes.

A camera 602 of system 600 may capture an image 604. Additionally, at or about the time camera 602 captures image 604, system 600 may determine camera position 606. System 600 may determine camera position 606 based on a global navigation satellite system (GNSS) signal, based on tracking camera 602 over time (e.g., based on inertial sensors), or using some other means.

System 600 may obtain road-height model 608. Road-height model 608 may include three dimensional (3D) points and/or normals (e.g., vectors pointing orthogonal from a surface) that describe a road. Road-height model 608 may be determined, for example, based on one or more images (e.g., captured by one or more cameras), one or more light detection and ranging (LIDAR) captures, and/or one or more radio detection and ranging (RADAR) captures. Additionally or alternatively, road-height model 608 may be based on a map, for example, a high-definition (HD) map of the road. An HD map of the road may include 3D points at a sub-meter resolution.

Projector 610 may detect objects in image 604. For example, projector 610 may include an object-detection machine-learning model trained to detect objects. The object-detection machine-learning model may be trained to detect certain objects, such as lane markings, lane edges, traffic markings, and/or other symbols on a road. Detecting the objects may include determining positions of the objects in an image. In some aspects, projector 610 may track the objects in multiple images, for example, using an optical-flow technique, to better detect the objects and/or to associate an object in multiple images.

Further, projector 610 may generate vectors 612 (e.g., one vector per objects). Vectors 612 may be from camera position 606 through representations of objects in image 604 as image 604 is positioned in an image plane (e.g., as described with regard to FIG. 2). Vectors 612 may be unit vectors with direction but not length.

Additionally, projector 610 may simulate road-height model 608 in the same 3D space as camera position 606 and vectors 612. Projector 610 may project vectors 612 to road-height model 608 (e.g., as described with regard to FIG. 2). Projector 610 may determine object positions 614 based on the intersections of vectors 612 and road-height model 608.

System 600 may store camera position 606 and vectors 612, for example, in a memory 616. Camera position 606 is illustrated twice in FIG. 6 for simplicity. Both instances of camera position 606 may be the same.

After obtaining road-height model 608, system 600 may obtain road-height model 618. At least some points of road-height model 618 may be more accurate than the corresponding points of road-height model 608. For example, road-height model 618 may be based on images, LIDAR captures, and/or RADAR captures captured closer to at least some points of road-height model 618 than the position from which the images, LIDAR captures, and/or RADAR on which road-height model 608 is based were captured.

Projector 610 may obtain camera position 606 and vectors 612 from memory 616 and project vectors 612 from camera position 606 to road-height model 618 to determine object positions 620. At least some of object positions 620 may be more accurate than object positions 614 based on at least some points of road-height model 618 being more accurate than the corresponding points of road-height model 608. Projector 610 may be the same projector 610 illustrated in multiple places within system 600 for simplicity. Alternatively, system 600 may include multiple instances of projector 610.

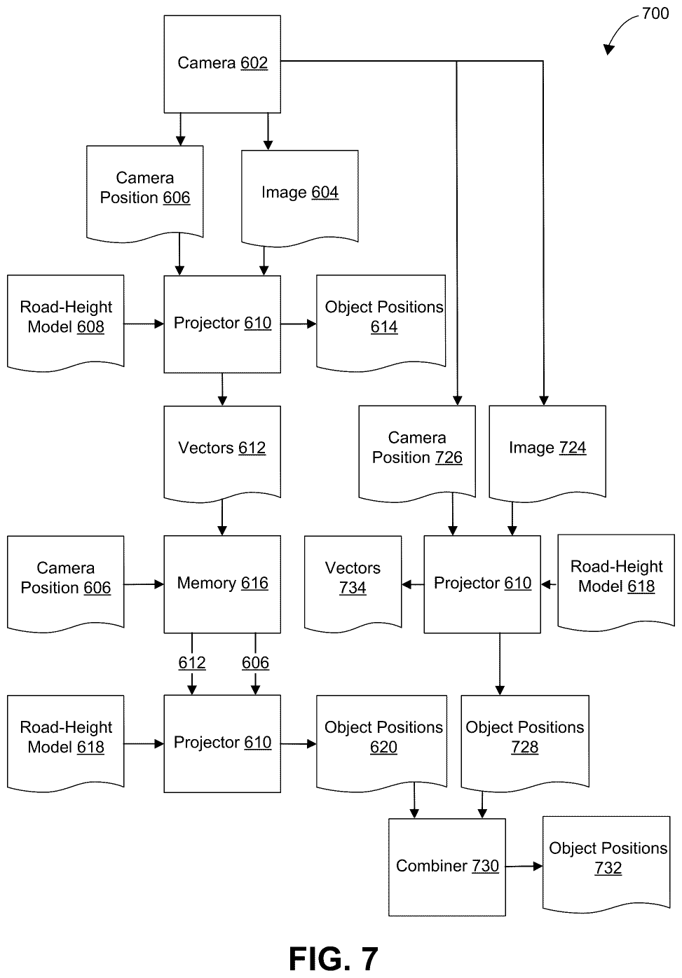

FIG. 7 is a block diagram illustrating an example system 700 that may determine object positions, according to various aspects of the present disclosure. System 700 illustrates several operations associated with determining object positions as blocks for descriptive purposes. System 700 may include all the elements of system 600.

Camera 602 may capture image 724 from camera position 726. Camera position 726 may be a different position than camera position 606. For example, camera position 726 may be farther down a road than camera position 606.

Projector 610 may detect objects in image 724 and determine vectors 734 between camera position 726 and representations of the objects in image 724 in an image plane. Projector 610 may further project vectors 734 to road-height model 618 to determine object positions 728. Object positions 728 may be the point at which vectors 734 intersect road-height model 618. Road-height model 618 is illustrated twice in FIG. 7 for simplicity. Both instances of road-height model 618 may be the same.

Combiner 730 may generate object positions 732 based on object positions 620 and object positions 728. For example, combiner 730 may average (or take a weighted average of) object positions 620 and object positions 728 to determine object positions 732. Object positions 732 may be an output of system 700. A vehicle may use object positions 732 to determine operational parameters for a vehicle and/or to display information to a driver of the vehicle.

System 700 may store any number of prior vectors 612 and corresponding prior camera position 606 at memory 616 and determine a corresponding number of object positions 620 each time a new road-height model 618 is received.

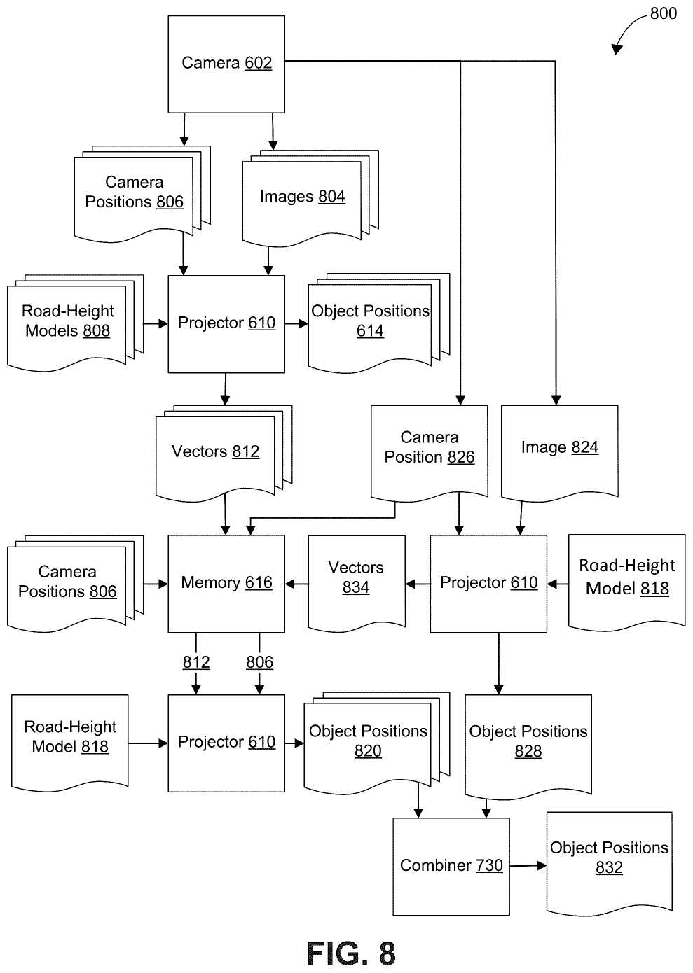

For example, FIG. 8 is a block diagram illustrating an example system 800 that may determine object positions, according to various aspects of the present disclosure. System 800 illustrates several operations associated with determining object positions as blocks for descriptive purposes. System 800 may include all the elements of system 700.

For example, camera 602 may capture any number of images 804 from any number of corresponding camera positions 806. Projector 610 may generate a number of vectors 612 between camera positions 806 and representations of objects in images 804 (e.g., one for each object in each of images 804). System 800 may store vectors 812 and camera positions 806 in memory 616. In some aspects, memory 616 may store a sliding window of vectors 812 and camera positions 806.

In FIG. 8, road-height model 818 may represent a most-recently-obtained road-height model, camera position 826 may represent a most-recently-obtained camera position, and image 824 may represent a most-recently-obtained image. Projector 610 may generate object positions 820 based on vectors 812, camera positions 806, and road-height model 818. For example, projector 610 may project each of vectors 812, from each of camera positions 806 to road-height model 818 to determine object positions 820.

Additionally, projector 610 may determine vectors 834 and object positions 828 based on image 824 and camera position 826. Vectors 834 may be vectors between camera position 826 and representations of objects in image 824 in an image plane. Once vectors 834 is determined, vectors 834 and camera position 826 may be stored in memory 616.

Combiner 730 may generate object positions 832 based on object positions 820 and object positions 828. In generating object positions 832, combiner 730 may weight object positions 820 generated based on newer camera positions 806 higher than object positions 820 based on older camera positions 806. Object positions 832 may be an output of system 800. A vehicle may use object positions 832 to determine operational parameters for a vehicle and/or to display information to a driver of the vehicle.

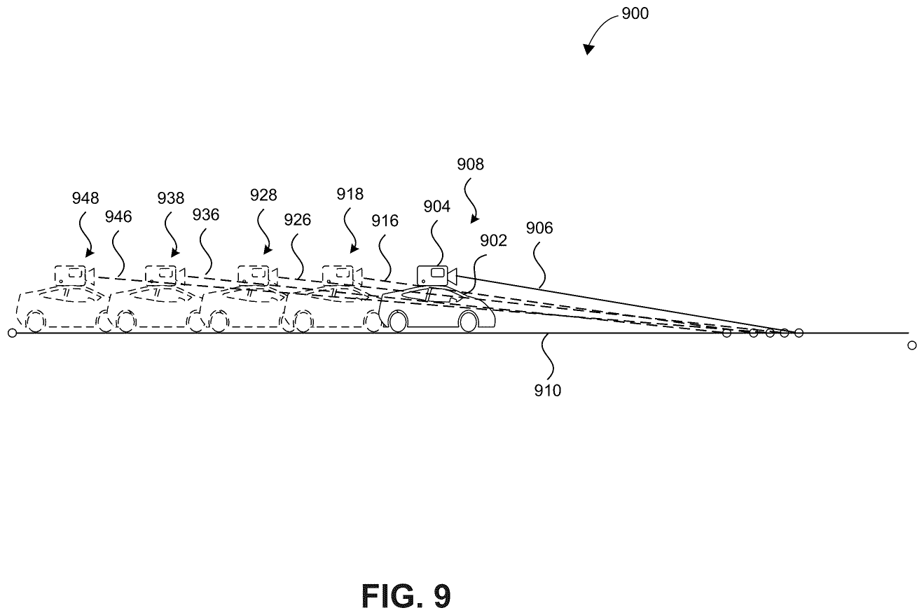

FIG. 9 is a diagram of an example environment 900 in which a vehicle 902 may determine an object position, according to various aspects of the present disclosure. FIG. 9 illustrates determining the object position based on a number of vectors and camera positions as described with regard to FIG. 8. For example, vehicle 902 may store vectors (e.g., vector 916, vector 926, vector 936, and vector 946) and a number of camera positions (e.g., camera position 918, camera position 928, camera position 938, and camera position 948). Vehicle 902 may project the vectors from their corresponding camera positions onto a most-recently-obtained road-height model 910 to determine a corresponding number of object positions. Vehicle 902 may determine one object position based on the number of object positions (e.g., using a weighted average of the object positions) and based on a most-recently-determined vector 906 and a most-recently-obtained camera position 908.

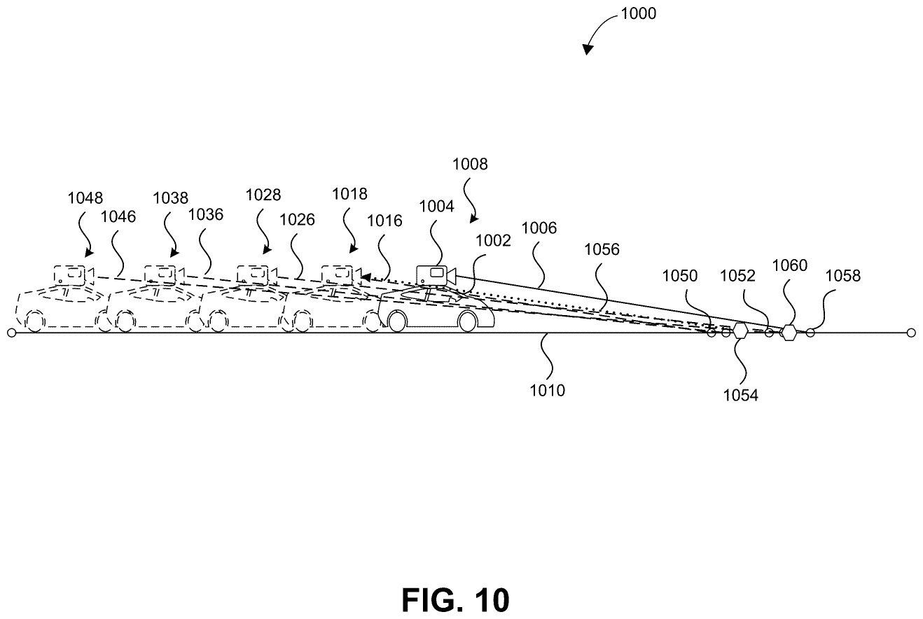

FIG. 10 is a diagram of an example environment 1000 in which a vehicle 1002 may determine an object position, according to various aspects of the present disclosure. Vehicle 1002 may apply a Kalman-filter based technique to determine the object position. For example, rather than storing a number of vectors and a number of camera positions, vehicle 1002 may store a filtered vector and a filtered camera position.

For example, at or about the time camera 1004 is at camera position 1018, vehicle 1002 may obtain camera position 1018 and generate vector 1016 based on an image of an object and camera position 1018. Vehicle 1002 may determine an object position 1050 based on vector 1016 and a most-recently-obtained road-height model.

Vehicle 1002 may also obtain vector 1026 and camera position 1028. Vector 1026 may be a filtered vector determined in a prior iteration of the process described with regard to FIG. 10. Camera position 1028 may be a prior camera position. Vehicle 1002 may determine a filtered object position 1052 based on vector 1026, camera position 1028, and the most-recently-obtained road-height model.

Vehicle 1002 may update object position 1050 (which is determined based on vector 1016) based on the filtered object position 1052 (which is determined based on vector 1026). For example, vehicle 1002 may generate updated filtered object position 1054 based on object position 1050 and filtered object position 1052.

Vehicle 1002 may generate a filtered vector 1056 based on updated filtered object position 1054 and store filtered vector 1056 for further iterations of the process described with regard to FIG. 10. For example, vehicle 1002 may determine filtered vector 1056 between updated filtered object position 1054 and camera position 1018. Vehicle 1002 may store camera position 1018 as the filtered camera position and store filtered vector 1056 as the filtered vector for further iterations of the process described with regard to FIG. 10.

For example, at or about the time camera 1004 is at camera position 1008, vehicle 1002 may obtain camera position 1008 and generate vector 1006 based on an image of an object and camera position 1008. Vehicle 1002 may determine an object position 1058 based on vector 1006 and a most-recently-obtained road-height model (e.g., road-height model 1010).

Additionally, vehicle 1002 may obtain filtered vector 1056 and camera position 1018. Vehicle 1002 may project filtered vector 1056 to road-height model 1010 to determine an updated filtered object position 1060. Updated filtered object position 1060 may be different than updated filtered object position 1054 because updated filtered object position 1060 may be based on projecting filtered vector 1056 to road-height model 1010 whereas updated filtered object position 1054 was based on projecting vector 1016 to a then-most-recently-obtained road-height model, which ma not the be the same as road-height model 1010.

Vehicle 1002 may update object position 1058 (which is determined based on vector 1006, camera position 1008, and road-height model 1010) based on the updated filtered object position 1060 (which is determined based on filtered vector 1056, vector 1016, and road-height model 1010). For example, vehicle 1002 may generate a new updated filtered object position based on object position 1058 and updated filtered object position 1060.

Vehicle 1002 may conserve memory by storing fewer vectors and camera positions than vehicle 902. For example, in the example given in FIG. 9, vehicle 902 stores vector 916, vector 926, vector 936, and vector 946 and camera position 918, camera position 928, camera position 938, and camera position 948. In contrast, vehicle 1002 stores one filtered vector and one filtered camera position at a time.

Vehicle 1002 may manage coordinate systems of the various images, vectors, camera positions, and/or object positions. For example, vehicle 1002 may track a pose (including position and orientation) of camera 1004 over time. Further, vehicle 1002 may transform positions (e.g., camera positions, vectors, and/or object positions) when comparing positions between coordinate systems. For example, vehicle 1002 may determine object position 1050 and filtered object position 1052 in a common coordinate system, for example, a reference coordinate system that is stationary (e.g., having a fixed origin). Alternatively, vehicle 1002 may determine object position 1050 and filtered object position 1052 in an ego-centric coordinate system based on a position of vehicle 1002 while camera 1004 is at camera position 1018 and update object position 1050 and filtered object position 1052 for use while camera 1004 is at camera position 1008.

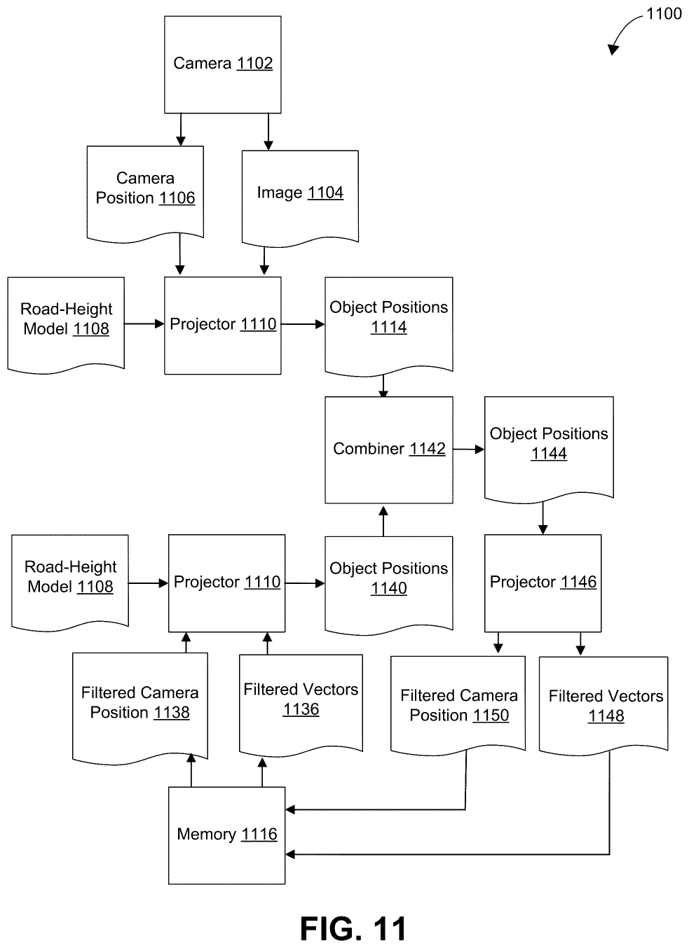

FIG. 11 is a block diagram illustrating an example system 1100 that may determine object positions, according to various aspects of the present disclosure. System 1100 illustrates several operations associated with determining object positions as blocks for descriptive purposes.

A camera 1102 of system 1100 may capture an image 1104. Additionally, at or about the time camera 1102 captures image 1104, system 1100 may determine camera position 1106. System 1100 may obtain road-height model 1108. Road-height model 1108 may include three dimensional (3D) points and/or normals (e.g., vectors pointing orthogonal from a surface) that describe a road.

Projector 1110 may detect objects in image 1104. Further, projector 1110 may generate vectors (e.g., one vector per objects). The vectors may be from camera position 1106 through representations of objects in image 1104 as image 1104 is positioned in an image plane (e.g., as described with regard to FIG. 2). In some cases, projector 1110 may simulate road-height model 1108 in the same 3D space as camera position 1106 and the vectors. Projector 1110 may project the vectors to road-height model 1108 (e.g., as described with regard to FIG. 2). Projector 1110 may determine object positions 1114 based on the intersections of the vectors and road-height model 1108.

System 1100 may have stored instances of filtered camera positions and filtered vectors from previous iterations of the process described with regard to FIG. 11. For example, system 1100 may have stored, at memory 1116, filtered camera position 1138 and filtered vectors 1136.

Projector 1110 may project filtered vectors 1136 from filtered camera position 1138 to road-height model 1108 to determine object positions 1140. For example, projector 1110 may project each of filtered vectors 1136 from filtered camera position 1138 to a respective point of intersection between the respective filtered vectors 1136 and road-height model 1108. Each point of intersection may be one of object positions 1140.

Combiner 1142 may combine object positions 1114 (generated based image 1104, camera position 1106, and road-height model 1108) with object positions 1140 (generated based on filtered vectors 1136, filtered camera position 1138, and road-height model 1108) to generate object positions 1144. For example, combiner 1142 may average (or perform a weighted average of) object positions 1114 and object positions 1140 to determine object positions 1144. Object positions 1144 may be an output of system 1100. A vehicle may use object positions 1144 to determine operational parameters for a vehicle and/or to display information to a driver of the vehicle.

In some aspects, projector 1146 may determine filtered vectors 1148 and filtered camera position 1150. For example, projector 1146 may determine camera position 1106 to be filtered camera position 1150. In some examples, projector 1146 may determine filtered vectors 1148 between filtered camera position 1150 and object positions 1144. Memory 1116 may store filtered vectors 1148 and filtered camera position 1150 for future iterations of the process described with regard to FIG. 11.

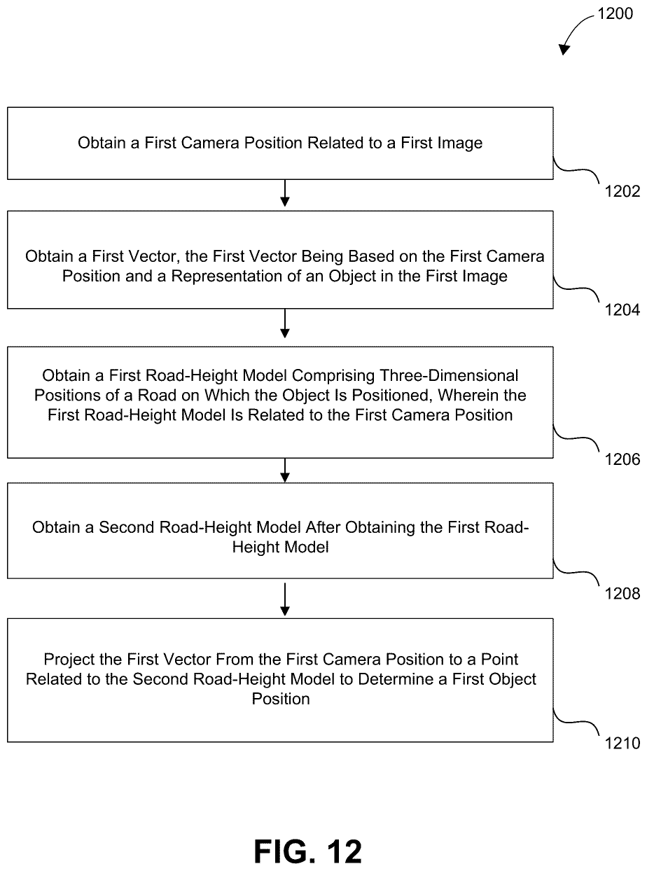

FIG. 12 is a flow diagram illustrating an example process 1200 for determining object positions, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1200. The one or more operations of process 1200 may be implemented as software components that are executed and run on one or more processors.

At block 1202, a computing device (or one or more components thereof) may obtain a first camera position related to a first image. For example, system 600 of FIG. 6 may obtain camera position 606. Camera position 606 may be related to image 604. For example, camera position 606 may be a position from which image 604 was captured.

At block 1204, the computing device (or one or more components thereof) may obtain a first vector, the first vector being based on the first camera position and a representation of an object in the first image. For example, projector 610 of FIG. 6 may generate a vector 612 based on camera position 606 and a representation of an object in image 604.

In some aspects, the first vector may be based on a projection from the first camera position through the representation of the object in the first image in an image plane to a point related to the first road-height model. For example, vector 612 may be projected through a representation of an object in image 604 to road-height model 608, (e.g., as described with regard to FIG. 2).

In some aspects, the first vector may be, or may include, a filtered vector determined based on a filtered object position and a filtered camera position. The first camera position may be, or may include, the filtered camera position. For example, vectors 612 may be a filtered vector, for example, tracked using a Kalman filter. Additionally, camera position 606 may be a filtered camera position, for example, tracked using a Kalman filter.

At block 1206, the computing device (or one or more components thereof) may obtain a first road-height model comprising three-dimensional positions of a road on which the object is positioned, wherein the first road-height model is related to the first camera position. For example, system 600 may obtain road-height model 608. Road-height model 608 may be, or may include, a three-dimensional model of positions of a road on which the object is positioned. Road-height model 608 may be a most-recently determined road-height model at the time camera position 606 is captured and/or at the time vectors 612 is determined.

At block 1208, the computing device (or one or more components thereof) may obtain a second road-height model after obtaining the first road-height model. For example, system 600 may obtain road-height model 618, after obtaining road-height model 608.

At block 1210, the computing device (or one or more components thereof) may project the first vector from the first camera position to a point related to the second road-height model to determine a first object position. For example, projector 610 may project the vector 612 to road-height model 618 to determine object position 620.

In some aspects, the computing device (or one or more components thereof) may obtain a plurality of camera positions, wherein each camera position of the plurality of camera positions is related to a respective image of a plurality of images; obtain a plurality of vectors, wherein each vector of the plurality of vectors is based on a respective camera position of the plurality of camera positions and a representation of the object in a respective image of the plurality of images; and project each vector of the plurality of vectors from a respective camera position to a respective point related to the second road-height model to determine a respective updated object position of a plurality of updated object positions. For example, system 600 of FIG. 6 may obtain several images 604 and several corresponding camera positions 606. Further, projector 610 may determine several vectors 612 based on the several camera positions and representations of an object in the several images 604. For example, for each of the images 604, projector 610 may project a vectors 612 from the camera position 606 from which the image was captured, through a representation of the object in the image. Having determined the vectors 612, having stored the camera positions 606 related to the vectors 612, and having received road-height model 618, projector 610 may project each of the vectors from its respective camera position 606 to road-height model 618. System 600 may determine an object position based on the points at which the projected vectors intersect road-height model 618. For example, system 600 may determine a weighted average of the points at which the projected vectors intersect road-height model 618.

In some aspects, the computing device (or one or more components thereof) may obtain a second camera position related to a second image; project a second vector from the second camera position through a representation of the object in the second image to a point related to the second road-height model to determine a second object position; and determine a third object position based on the second object position and the first object position. For example, system 700 of FIG. 7 may obtain camera position 726 related to image 724. Camera position 726 may be related to image 724. For example, camera position 726 may be a position from which image 724 was captured. Further, projector 610 may project a vector through a representation of the object in image 724 to a point related to road-height model 618 to determine object position 728. Further combiner 730 may determine object position 732 based on object position 620 (e.g., determined at block 1210) and object position 728.

In some aspects, the third object position may be based on a weighted average of the second object position and the first object position.

In some aspects, the object may be, or may include, a lane marking on the road and/or a symbol on the road; or traffic information on the road. For example, the object may be, or may include, lane dividers 106, lane edges 108, and/or road symbols 110 of FIG. 1.

In some aspects, the computing device (or one or more components thereof) may be, or may include, a computing device of a vehicle. In some aspects, the computing device (or one or more components thereof) may adjust an operating parameter of the vehicle based on first object position. In some aspects, the operating parameter may be associated with at least one of a path for the vehicle to travel, an automatic braking parameter for operating one or more brakes of the vehicle, a lane change parameter for causing the vehicle to navigate from a first lane to a second lane, or displaying information based on the first object position using a user interface of the vehicle.

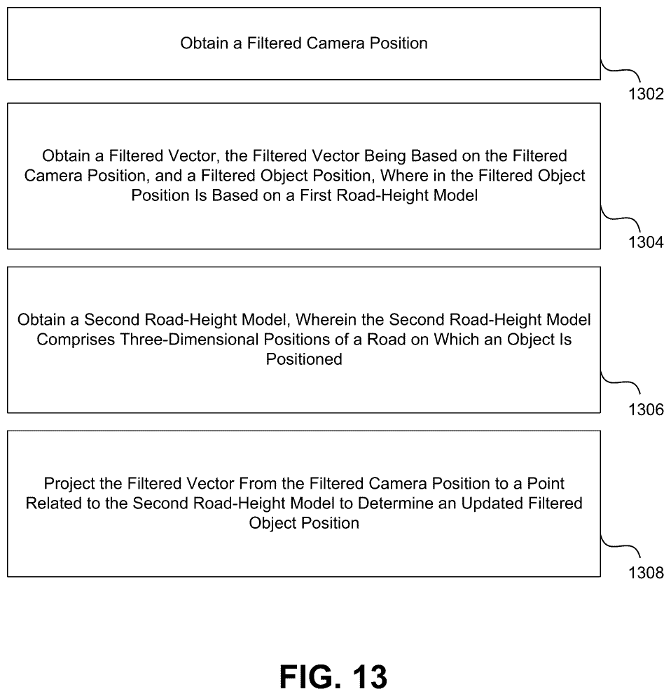

FIG. 13 is a flow diagram illustrating an example process 1300 for determining object positions, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1300. The one or more operations of process 1300 may be implemented as software components that are executed and run on one or more processors.

At block 1302, a computing device (or one or more components thereof) may obtain a filtered camera position. For example, system 1100 of FIG. 11 may obtain filtered camera position 1138.

In some aspects, the filtered object position may be determined using a Kalman filter. For example, filtered camera position 1138 may be tracked using a Kalman filter.

At block 1304, the computing device (or one or more components thereof) may obtain a filtered vector, the filtered vector being based on the filtered camera position, and a filtered object position, where in the filtered object position is based on a first road-height model. For example, system 1100 may obtain a filtered vector 1136. Filtered vector 1136 may be based on filtered camera position 1138 and object position 1144. Object position 1144 may be based on a prior instance of road-height model 1108.

At block 1306, the computing device (or one or more components thereof) may obtain a second road-height model, wherein the second road-height model comprises three-dimensional positions of a road on which an object is positioned. For example, system 1100 may receive a new instance of road-height model 1108.

At block 1308, the computing device (or one or more components thereof) may project the filtered vector from the filtered camera position to a point related to the second road-height model to determine an updated filtered object position. For example, projector 1110 may project filtered vector 1136 from filtered camera position 1138 to the new instance of road-height model 1108 to determine a new instance of object positions 1140.

In some aspects, the computing device (or one or more components thereof) may obtain a second camera position related to a second image; project a second vector from the second camera position through a representation of an object in the second image in an image plane to a point related to the second road-height model to determine a second object position; and determine a third object position based on the second object position and the updated filtered object position. For example, system 1100 may obtain camera position 1106. Camera position 1106 may be related to image 1104. Projector 1110 may project a vector from camera position 1106 through a representation of an object in image 1104 to road-height model 1108 to determine object positions 1114. Further, combiner 1142 may determine a new instance of object positions 1144 based on object positions 1114 and the new instance of object positions 1140.

In some aspects, the filtered camera position may be, or may include, a first filtered camera position. The filtered vector may be, or may include, a first filtered vector. The updated filtered object position may be, or may include, a first updated filtered object position. The computing device (or one or more components thereof) may store the second camera position as a second filtered camera position; store the second vector as a second filtered vector; obtain a third road-height model; and project the second filtered vector from the second filtered camera position to the third road-height model to determine a second updated filtered object position. For example, system 1100 may store camera position 1106 at memory 1116 as filtered camera position 1150 and store filtered vectors 1148 at memory 1116. System 1100 may obtain a new instance of road-height model 1108. Projector 1110 may project filtered vectors 1136 (which may be filtered vectors 1148 as stored in memory 1116) from filtered camera position 1138 (which may be filtered camera position 1150 as stored in memory 1116) to the new instance of road-height model 1108 to determine a new instance of object positions 1140.

In some aspects, the computing device (or one or more components thereof) may obtain a third camera position related to a third image; project a third vector from the third camera position through a representation of the object in the third image in an image plane to the third road-height model to determine a fourth object position; and determine a third updated object position based on the fourth object position and the second updated filtered object position. For example, system 1100 may obtain a new instance of camera position 1106. The new instance of camera position 1106 may relate to a new instance of image 1104. Projector 1110 may project a new vector from the new instance of camera position 1106 to the new instance of road-height model 1108 to determine a new instance of object positions 1114. Combiner 1142 may determine a new instance of object positions 1144 based on the new instance of object positions 1114 and the new instance of object positions 1140.

In some aspects, the object may be, or may include, a lane marking on the road and/or a symbol on the road; or traffic information on the road. For example, the object may be, or may include, lane dividers 106, lane edges 108, and/or road symbols 110 of FIG. 1.

In some aspects, the computing device (or one or more components thereof) may be, or may include, a computing device of a vehicle. In some aspects, the computing device (or one or more components thereof) may adjust an operating parameter of the vehicle based on first object position. In some aspects, the operating parameter may be associated with at least one of a path for the vehicle to travel, an automatic braking parameter for operating one or more brakes of the vehicle, a lane change parameter for causing the vehicle to navigate from a first lane to a second lane, or displaying information based on the first object position using a user interface of the vehicle.

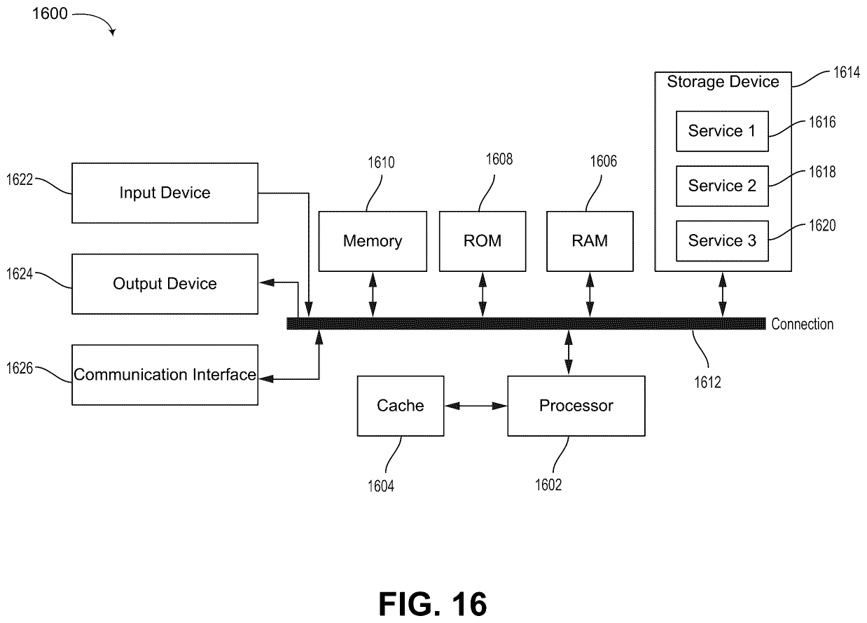

In some examples, as noted previously, the methods described herein (e.g., process 1200 of FIG. 12, process 1300 of FIG. 13, and/or other methods described herein) can be performed, in whole or in part, by a computing device or apparatus. In one example, one or more of the methods can be performed by a vehicle (and/or a computing system thereof), such as vehicle 302 of FIG. 3A, and FIG. 3B, vehicle 402 of FIG. 4, vehicle 502 of FIG. 5, vehicle 902 of FIG. 9, vehicle 1002 of FIG. 10, or by a system (which may be implemented by a computing system), such as system 600 FIG. 6, system 700 of FIG. 7, system 800 of FIG. 8, system 1100 of FIG. 11, or by another system or device. In another example, one or more of the methods (e.g., process 1200, process 1300, and/or other methods described herein) can be performed, in whole or in part, by the computing-device architecture 1600 shown in FIG. 16. For instance, a computing device with the computing-device architecture 1600 shown in FIG. 16 can include, or be included in, the components of vehicle 302, vehicle 402, vehicle 502, system 600, system 700, system 800, vehicle 902, vehicle 1002, and/or system 1100, and can implement the operations of process 1200, process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1200, process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

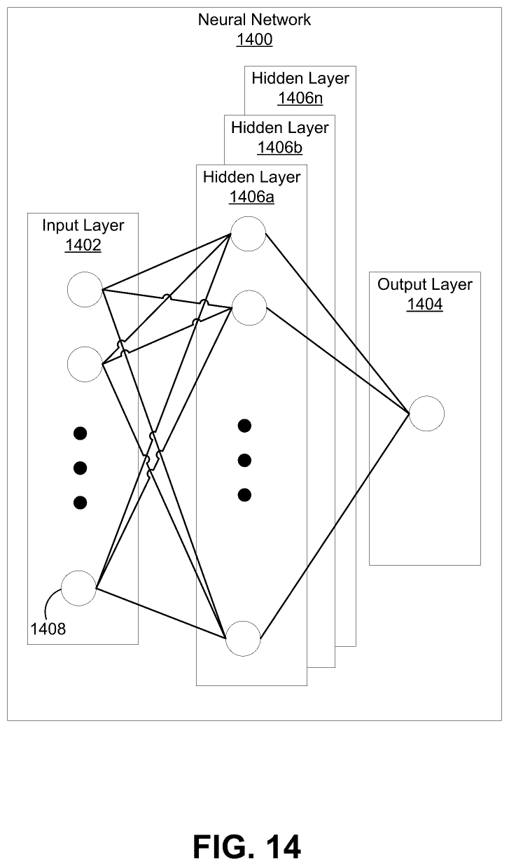

FIG. 14 is an illustrative example of a neural network 1400 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1400 may detect objects in images.

An input layer 1402 includes input data. In one illustrative example, input layer 1402 can include data representing image 604 of FIG. 6, image 704 of FIG. 7, images 804 of FIG. 8, and/or image 1104 of FIG. 11. Neural network 1400 includes multiple hidden layers, for example, hidden layers 1406a, 1406b, through 1406n. The hidden layers 1406a, 1406b, through hidden layer 1406n include “n” number of hidden layers, where “n” is an integer greater than or equal to one. The number of hidden layers can be made to include as many layers as needed for the given application. Neural network 1400 further includes an output layer 1404 that provides an output resulting from the processing performed by the hidden layers 1406a, 1406b, through 1406n. In one illustrative example, output layer 1404 can provide detections of objects in image 604, image 704, and/or images 804, image 1104.

Neural network 1400 may be, or may include, a multi-layer neural network of interconnected nodes. Each node can represent a piece of information. Information associated with the nodes is shared among the different layers and each layer retains information as information is processed. In some cases, neural network 1400 can include a feed-forward network, in which case there are no feedback connections where outputs of the network are fed back into itself. In some cases, neural network 1400 can include a recurrent neural network, which can have loops that allow information to be carried across nodes while reading in input.

Information can be exchanged between nodes through node-to-node interconnections between the various layers. Nodes of input layer 1402 can activate a set of nodes in the first hidden layer 1406a. For example, as shown, each of the input nodes of input layer 1402 is connected to each of the nodes of the first hidden layer 1406a. The nodes of first hidden layer 1406a can transform the information of each input node by applying activation functions to the input node information. The information derived from the transformation can then be passed to and can activate the nodes of the next hidden layer 1406b, which can perform their own designated functions. Example functions include convolutional, up-sampling, data transformation, and/or any other suitable functions. The output of the hidden layer 1406b can then activate nodes of the next hidden layer, and so on. The output of the last hidden layer 1406n can activate one or more nodes of the output layer 1404, at which an output is provided. In some cases, while nodes (e.g., node 1408) in neural network 1400 are shown as having multiple output lines, a node has a single output and all lines shown as being output from a node represent the same output value.

In some cases, each node or interconnection between nodes can have a weight that is a set of parameters derived from the training of neural network 1400. Once neural network 1400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1400 to be adaptive to inputs and able to learn as more and more data is processed.

Neural network 1400 may be pre-trained to process the features from the data in the input layer 1402 using the different hidden layers 1406a, 1406b, through 1406n in order to provide the output through the output layer 1404. In an example in which neural network 1400 is used to identify features in images, neural network 1400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1400 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1400 is trained well enough so that the weights of the layers are accurately tuned.

For the example of identifying objects in images, the forward pass can include passing a training image through neural network 1400. The weights are initially randomized before neural network 1400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as. The loss can be set to be equal to the value of Etotal.

The loss (or error) will be high for the first training images since the actual values will be much different than the predicted output. The goal of training is to minimize the amount of loss so that the predicted output is the same as the training label. Neural network 1400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as, where w denotes a weight, wi denotes the initial weight, and n denotes a learning rate. The learning rate can be set to any suitable value, with a high learning rate including larger weight updates and a lower value indicating smaller weight updates.

Neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1400 can include any other deep network other than a CNN, such as an autoencoder, a deep belief nets (DBNs), a Recurrent Neural Networks (RNNs), among others.

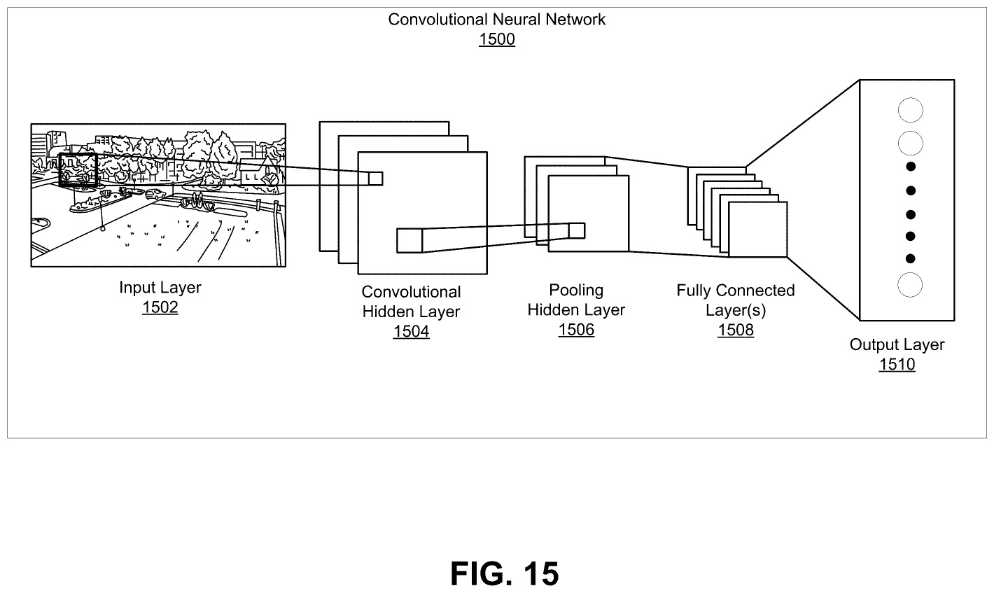

FIG. 15 is an illustrative example of a convolutional neural network (CNN) 1500. The input layer 1502 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1504, an optional non-linear activation layer, a pooling hidden layer 1506, and fully connected layer 1508 (which fully connected layer 1508 can be hidden) to get an output at the output layer 1510. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 can be the convolutional hidden layer 1504. The convolutional hidden layer 1504 can analyze image data of the input layer 1502. Each node of the convolutional hidden layer 1504 is connected to a region of nodes (pixels) of the input image called a receptive field. The convolutional hidden layer 1504 can be considered as one or more filters (each filter corresponding to a different activation or feature map), with each convolutional iteration of a filter being a node or neuron of the convolutional hidden layer 1504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1504. Each connection between a node and a receptive field for that node learns a weight and, in some cases, an overall bias such that each node learns to analyze its particular local receptive field in the input image. Each node of the convolutional hidden layer 1504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1504 is due to each node of the convolutional layer being applied to its corresponding receptive field. For example, a filter of the convolutional hidden layer 1504 can begin in the top-left corner of the input image array and can convolve around the input image. As noted above, each convolutional iteration of the filter can be considered a node or neuron of the convolutional hidden layer 1504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1504.

The mapping from the input layer to the convolutional hidden layer 1504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1504 can include several activation maps in order to identify multiple features in an image. The example shown in FIG. 15 includes three activation maps. Using three activation maps, the convolutional hidden layer 1504 can detect three different kinds of features, with each feature being detectable across the entire image.

In some examples, a non-linear hidden layer can be applied after the convolutional hidden layer 1504. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1504.

The pooling hidden layer 1506 can be applied after the convolutional hidden layer 1504 (and after the non-linear hidden layer when used). The pooling hidden layer 1506 is used to simplify the information in the output from the convolutional hidden layer 1504. For example, the pooling hidden layer 1506 can take each activation map output from the convolutional hidden layer 1504 and generates a condensed activation map (or feature map) using a pooling function. Max-pooling is one example of a function performed by a pooling hidden layer. Other forms of pooling functions be used by the pooling hidden layer 1506, such as average pooling, L2-norm pooling, or other suitable pooling functions. A pooling function (e.g., a max-pooling filter, an L2-norm filter, or other suitable pooling filter) is applied to each activation map included in the convolutional hidden layer 1504. In the example shown in FIG. 15, three pooling filters are used for the three activation maps in the convolutional hidden layer 1504.

In some examples, max-pooling can be used by applying a max-pooling filter (e.g., having a size of 2×2) with a stride (e.g., equal to a dimension of the filter, such as a stride of 2) to an activation map output from the convolutional hidden layer 1504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1504 having a dimension of 24×24 nodes, the output from the pooling hidden layer 1506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1506 to every one of the output nodes in the output layer 1510. Using the example above, the input layer includes 28×28 nodes encoding the pixel intensities of the input image, the convolutional hidden layer 1504 includes 3×24×24 hidden feature nodes based on application of a 5×5 local receptive field (for the filters) to three activation maps, and the pooling hidden layer 1506 includes a layer of 3×12×12 hidden feature nodes based on application of max-pooling filter to 2×2 regions across each of the three feature maps. Extending this example, the output layer 1510 can include ten output nodes. In such an example, every node of the 3×12×12 pooling hidden layer 1506 is connected to every node of the output layer 1510.

The fully connected layer 1508 can obtain the output of the previous pooling hidden layer 1506 (which should represent the activation maps of high-level features) and determines the features that most correlate to a particular class. For example, the fully connected layer 1508 can determine the high-level features that most strongly correlate to a particular class and can include weights (nodes) for the high-level features. A product can be computed between the weights of the fully connected layer 1508 and the pooling hidden layer 1506 to obtain probabilities for the different classes. For example, if the CNN 1500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1510 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of vehicle 302 of FIG. 3A, and FIG. 3B, vehicle 402 of FIG. 4, vehicle 502 of FIG. 5, vehicle 902 of FIG. 9, vehicle 1002 of FIG. 10, system 600 FIG. 6, system 700 of FIG. 7, system 800 of FIG. 8, system 1100 of FIG. 11, and/or other devices, modules, or systems described herein. Additionally or alternatively, computing-device architecture 1600 may be configured to perform process 1200, process 1300, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for determining positions of objects; the apparatus comprising: at least one memory; and at least one processor coupled to the at least one memory and configured to: obtain a first camera position related to a first image; obtain a first vector, the first vector being based on the first camera position and a representation of an object in the first image; obtain a first road-height model comprising three-dimensional positions of a road on which the object is positioned, wherein the first road-height model is related to the first camera position; obtain a second road-height model after obtaining the first road-height model; and project the first vector from the first camera position to a point related to the second road-height model to determine a first object position.

Aspect 2. The apparatus of aspect 1, wherein the at least one processor is configured to: obtain a second camera position related to a second image; project a second vector from the second camera position through a representation of the object in the second image to a point related to the second road-height model to determine a second object position; and determine a third object position based on the second object position and the first object position.

Aspect 3. The apparatus of aspect 2, wherein the third object position is based on a weighted average of the second object position and the first object position.

Aspect 4. The apparatus of any one of aspects 1 to 3, wherein the first vector is based on a projection from the first camera position through the representation of the object in the first image in an image plane to a point related to the first road-height model.

Aspect 5. The apparatus of any one of aspects 1 to 4, wherein the at least one processor is configured to: obtain a plurality of camera positions, wherein each camera position of the plurality of camera positions is related to a respective image of a plurality of images; obtain a plurality of vectors, wherein each vector of the plurality of vectors is based on a respective camera position of the plurality of camera positions and a representation of the object in a respective image of the plurality of images; and project each vector of the plurality of vectors from a respective camera position to a respective point related to the second road-height model to determine a respective updated object position of a plurality of updated object positions.

Aspect 6. The apparatus of aspect 5, wherein the at least one processor is configured to: obtain a second camera position related to a second image; project a second vector from the second camera position through a representation of the object in the second image in an image plane to a point related to the second road-height model to determine a second object position; and determine a third object position based on the second object position and the plurality of updated object positions.

Aspect 7. The apparatus of any one of aspects 1 to 6, wherein: the first vector comprises a filtered vector determined based on a filtered object position and a filtered camera position; and the first camera position comprises the filtered camera position.

Aspect 8. The apparatus of aspect 7, wherein the filtered object position is determined using a Kalman filter.

Aspect 9. The apparatus of any one of aspects 1 to 8, wherein the object comprises at least one of: a lane marking on the road; and a symbol on the road; or traffic information on the road.

Aspect 10. The apparatus of any one of aspects 1 to 9, wherein the apparatus comprises a computing device of a vehicle.

Aspect 11. The apparatus of aspect 10, wherein the at least one processor is configured to adjust an operating parameter of the vehicle based on first object position.

Aspect 12. The apparatus of aspect 11, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information based on the first object position using a user interface of the vehicle.

Aspect 13. An apparatus for determining positions of objects; the apparatus comprising: at least one memory; and at least one processor coupled to the at least one memory and configured to: obtain a filtered camera position; obtain a filtered vector, the filtered vector being based on the filtered camera position, and a filtered object position, where in the filtered object position is based on a first road-height model; obtain a second road-height model, wherein the second road-height model comprises three-dimensional positions of a road on which an object is positioned; and project the filtered vector from the filtered camera position to a point related to the second road-height model to determine an updated filtered object position.

Aspect 14. The apparatus of aspect 13, wherein the filtered object position is determined using a Kalman filter.

Aspect 15. The apparatus of any one of aspects 13 or 14, wherein the at least one processor is configured to: obtain a second camera position related to a second image; project a second vector from the second camera position through a representation of an object in the second image in an image plane to a point related to the second road-height model to determine a second object position; and determine a third object position based on the second object position and the updated filtered object position.

Aspect 16. The apparatus of aspect 15, wherein: the filtered camera position comprises a first filtered camera position; the filtered vector comprises a first filtered vector; the updated filtered object position comprises a first updated filtered object position; and the at least one processor is configured to: store the second camera position as a second filtered camera position; store the second vector as a second filtered vector; obtain a third road-height model; and project the second filtered vector from the second filtered camera position to the third road-height model to determine a second updated filtered object position.

Aspect 17. The apparatus of aspect 16, wherein the at least one processor is configured to: obtain a third camera position related to a third image; project a third vector from the third camera position through a representation of the object in the third image in an image plane to the third road-height model to determine a fourth object position; and determine a third updated object position based on the fourth object position and the second updated filtered object position.

Aspect 18. The apparatus of any one of aspects 13 to 17, wherein the object comprises at least one of: a lane marking on the road; and a symbol on the road; or traffic information on the road.

Aspect 19. The apparatus of any one of aspects 13 to 18, wherein the apparatus comprises a computing device of a vehicle.

Aspect 20. The apparatus of aspect 19, wherein the at least one processor is configured to adjust an operating parameter of the vehicle based on updated filtered object position.

Aspect 21. The apparatus of aspect 20, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information based on the updated filtered object position using a user interface of the vehicle.

Aspect 22. A method for determining positions of objects; the method comprising: obtaining a first camera position related to a first image; obtaining a first vector, the first vector being based on the first camera position and a representation of an object in the first image; obtaining a first road-height model comprising three-dimensional positions of a road on which the object is positioned, wherein the first road-height model is related to the first camera position; obtaining a second road-height model after obtaining the first road-height model; and projecting the first vector from the first camera position to a point related to the second road-height model to determine a first object position.

Aspect 23. The method of aspect 22, further comprising: obtaining a second camera position related to a second image; projecting a second vector from the second camera position through a representation of the object in the second image to a point related to the second road-height model to determine a second object position; and determining a third object position based on the second object position and the first object position.

Aspect 24. The method of aspect 23, wherein the third object position is based on a weighted average of the second object position and the first object position.

Aspect 25. The method of any one of aspects 22 to 24, wherein the first vector is based on a projection from the first camera position through the representation of the object in the first image in an image plane to a point related to the first road-height model.

Aspect 26. The method of any one of aspects 22 to 25, further comprising: obtaining a plurality of camera positions, wherein each camera position of the plurality of camera positions is related to a respective image of a plurality of images; obtaining a plurality of vectors, wherein each vector of the plurality of vectors is based on a respective camera position of the plurality of camera positions and a representation of the object in a respective image of the plurality of images; and projecting each vector of the plurality of vectors from a respective camera position to a respective point related to the second road-height model to determine a respective updated object position of a plurality of updated object positions.

Aspect 27. The method of aspect 26, further comprising: obtaining a second camera position related to a second image; projecting a second vector from the second camera position through a representation of the object in the second image in an image plane to a point related to the second road-height model to determine a second object position; and determining a third object position based on the second object position and the plurality of updated object positions.

Aspect 28. The method of any one of aspects 22 to 27, wherein: the first vector comprises a filtered vector determined based on a filtered object position and a filtered camera position; and the first camera position comprises the filtered camera position.

Aspect 29. The method of aspect 28, wherein the filtered object position is determined using a Kalman filter.

Aspect 30. The method of any one of aspects 22 to 29 wherein the object comprises at least one of: a lane marking on the road; and a symbol on the road; or traffic information on the road.

Aspect 31. The method of any one of aspects 22 to 30, wherein the method is to be performed by a computing device of a vehicle.

Aspect 32. The method of aspect 31, further comprising adjusting an operating parameter of the vehicle based on first object position.

Aspect 33. The method of aspect 32, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information based on the first object position using a user interface of the vehicle.

Aspect 34. A method for determining positions of objects; the method comprising: obtaining a filtered camera position; obtaining a filtered vector, the filtered vector being based on the filtered camera position, and a filtered object position, where in the filtered object position is based on a first road-height model; obtaining a second road-height model, wherein the second road-height model comprises three-dimensional positions of a road on which an object is positioned; and projecting the filtered vector from the filtered camera position to a point related to the second road-height model to determine an updated filtered object position.

Aspect 35. The method of aspect 34, wherein the filtered object position is determined using a Kalman filter.

Aspect 36. The method of any one of aspects 34 or 35, further comprising: obtaining a second camera position related to a second image; projecting a second vector from the second camera position through a representation of an object in the second image in an image plane to a point related to the second road-height model to determine a second object position; and determining a third object position based on the second object position and the updated filtered object position.

Aspect 37. The method of aspect 36, wherein: the filtered camera position comprises a first filtered camera position; the filtered vector comprises a first filtered vector; and the updated filtered object position comprises a first updated filtered object position; and further comprising: storing the second camera position as a second filtered camera position; storing the second vector as a second filtered vector; obtaining a third road-height model; and projecting the second filtered vector from the second filtered camera position to the third road-height model to determine a second updated filtered object position.

Aspect 38. The method of aspect 37, further comprising: obtaining a third camera position related to a third image; projecting a third vector from the third camera position through a representation of the object in the third image in an image plane to the third road-height model to determine a fourth object position; and determining a third updated object position based on the fourth object position and the second updated filtered object position.

Aspect 39. The method of any one of aspects 34 to 38, wherein the object comprises at least one of: a lane marking on the road; and a symbol on the road; or traffic information on the road.

Aspect 40. The method of any one of aspects 34 to 39, wherein the method is to be performed by a computing device of a vehicle.

Aspect 41. The method of aspect 40, further comprising adjusting an operating parameter of the vehicle based on updated filtered object position.

Aspect 42. The method of aspect 41, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information based on the updated filtered object position using a user interface of the vehicle.

Aspect 43. A non-transitory computer-readable storage medium having stored thereon instructions that, when executed by at least one processor, cause the at least one processor to perform operations according to any of aspects 22 to 42.

Aspect 44. An apparatus for providing virtual content for display, the apparatus comprising one or more means for perform operations according to any of aspects 22 to 24.

What is claimed is:

1. An apparatus for determining positions of objects; the apparatus comprising:
at least one memory; and
at least one processor coupled to the at least one memory and configured to:
obtain a first camera position related to a first image;
obtain a first vector, the first vector being based on the first camera position and a representation of an object in the first image;
obtain a first road-height model comprising three-dimensional positions of a road on which the object is positioned, wherein the first road-height model is related to the first camera position;
obtain a second road-height model after obtaining the first road-height model; and
project the first vector from the first camera position to a point related to the second road-height model to determine a first object position.

2. The apparatus of claim 1, wherein the at least one processor is configured to:
obtain a second camera position related to a second image;
project a second vector from the second camera position through a representation of the object in the second image to a point related to the second road-height model to determine a second object position; and
determine a third object position based on the second object position and the first object position.

3. The apparatus of claim 2, wherein the third object position is based on a weighted average of the second object position and the first object position.

4. The apparatus of claim 1, wherein the first vector is based on a projection from the first camera position through the representation of the object in the first image in an image plane to a point related to the first road-height model.

5. The apparatus of claim 1, wherein the at least one processor is configured to:
obtain a plurality of camera positions, wherein each camera position of the plurality of camera positions is related to a respective image of a plurality of images;
obtain a plurality of vectors, wherein each vector of the plurality of vectors is based on a respective camera position of the plurality of camera positions and a representation of the object in a respective image of the plurality of images; and
project each vector of the plurality of vectors from a respective camera position to a respective point related to the second road-height model to determine a respective updated object position of a plurality of updated object positions.

6. The apparatus of claim 5, wherein the at least one processor is configured to:
obtain a second camera position related to a second image;
project a second vector from the second camera position through a representation of the object in the second image in an image plane to a point related to the second road-height model to determine a second object position; and
determine a third object position based on the second object position and the plurality of updated object positions.

7. The apparatus of claim 1, wherein:
the first vector comprises a filtered vector determined based on a filtered object position and a filtered camera position; and
the first camera position comprises the filtered camera position.

8. The apparatus of claim 7, wherein the filtered object position is determined using a Kalman filter.

9. The apparatus of claim 1, wherein the object comprises at least one of:
a lane marking on the road; and
a symbol on the road; or traffic information on the road.

10. The apparatus of claim 1, wherein the apparatus comprises a computing device of a vehicle.

11. The apparatus of claim 10, wherein the at least one processor is configured to adjust an operating parameter of the vehicle based on first object position.

12. The apparatus of claim 11, wherein the operating parameter is associated with at least one of a path for the vehicle to travel, an automatic braking parameter for operating one or more brakes of the vehicle, a lane change parameter for causing the vehicle to navigate from a first lane to a second lane, or displaying information based on the first object position using a user interface of the vehicle.

13. An apparatus for determining positions of objects; the apparatus comprising:
at least one memory; and
at least one processor coupled to the at least one memory and configured to:
obtain a filtered camera position;
obtain a filtered vector, the filtered vector being based on the filtered camera position, and a filtered object position, where in the filtered object position is based on a first road-height model;
obtain a second road-height model, wherein the second road-height model comprises three-dimensional positions of a road on which an object is positioned; and
project the filtered vector from the filtered camera position to a point related to the second road-height model to determine an updated filtered object position.

14. The apparatus of claim 13, wherein the filtered object position is determined using a Kalman filter.

15. The apparatus of claim 13, wherein the at least one processor is configured to:
obtain a second camera position related to a second image;
project a second vector from the second camera position through a representation of an object in the second image in an image plane to a point related to the second road-height model to determine a second object position; and
determine a third object position based on the second object position and the updated filtered object position.

16. The apparatus of claim 15, wherein:
the filtered camera position comprises a first filtered camera position;
the filtered vector comprises a first filtered vector;
the updated filtered object position comprises a first updated filtered object position; and
the at least one processor is configured to:
store the second camera position as a second filtered camera position;
store the second vector as a second filtered vector;
obtain a third road-height model; and
project the second filtered vector from the second filtered camera position to the third road-height model to determine a second updated filtered object position.

17. The apparatus of claim 16, wherein the at least one processor is configured to:
obtain a third camera position related to a third image;
project a third vector from the third camera position through a representation of the object in the third image in an image plane to the third road-height model to determine a fourth object position; and
determine a third updated object position based on the fourth object position and the second updated filtered object position.

18. The apparatus of claim 13, wherein the object comprises at least one of:
a lane marking on the road; and
a symbol on the road; or traffic information on the road.

19. The apparatus of claim 13, wherein the apparatus comprises a computing device of a vehicle.

20. The apparatus of claim 19, wherein the at least one processor is configured to adjust an operating parameter of the vehicle based on updated filtered object position.
